(19) United States
(12) Patent Application Publication
(10) Pub. No.: US 2014/0004838 A1
(43) Pub. Date: Jan. 2, 2014

(54) SYSTEM AND METHOD FOR MULTI-CHANNEL MOBILE CUSTOMER ASSISTANCE FRAMEWORK

(71) Applicant: Infosys Limited, Bangalore (IN)

(72) Inventors: Jithesh Sathyan, Kollam (IN); Manesh Sadasivan, Kottayam (IN); Darshan Shankavaram, Bangalore (IN)

(21) Appl. No.: 13/929,747

(22) Filed: Jun. 27, 2013

(30) Foreign Application Priority Data
Jun. 27, 2012 (IN) 2546/CHE/2012

(51) Int. Cl. H04W 4/00

(52) U.S. Cl. CPC H04W 4/001
USPC 455/414.3

(57) ABSTRACT

Systems and methods are provided for enabling multi-channel customer assistance for a user of a wireless telecommunication device. The current mobile assistance solutions are more a set of stored datasets which are merely queried on demand. The approach is based on presence of one or more customer assistance engines on a mobile device and a server in communication with the mobile device. Implementation of these engines is disclosed.

### RELATED APPLICATION DATA

This application claims priority to India Patent Application No. 2546/CHE/2012, filed Jun. 27, 2012, the disclosure of which is hereby incorporated by reference in its entirety.

### FIELD OF THE INVENTION

The present invention relates generally to the field of methods and systems of providing customer assistance, and, more particularly, to customer assistance systems and methods for wireless telecommunication devices.

### BACKGROUND OF THE INVENTION

Mobile industry is evolving rapidly and enterprises are coming up with new compelling mobile applications to enhance the customer base and provide better experience. Customer assistance solutions are going to be an essential offering from enterprises. Mobile platforms enable personal assistance and provide user-centric solutions that aid a mobile user with information. With the wide availability of downloadable sources and applications available for telecommunication devices such as smartphone, and the increasing costs of customer care, ensuring efficient and less cumbersome support when problems arise is an increasing necessity. Traditionally, customer assistance applications were made available customer care centers and customer service representatives (hereinafter referred to as ‘CSRs’) took the extensive and time-consuming task of asking customers complex questions pertaining to their wireless devices for problem diagnosis. This has been often aided with the use of Interactive Voice Response (hereinafter referred to as ‘IVR’). IVR is a traditional methodology of delivering customer assistance based on a request-response model. It primarily involves the use of computer technology to provide prerecorded or computer-generated audio responses to customer touchtone input. The IVR system would then take the necessary instructions from the consumer by recording the tones of the number selections that the consumer enters on the key pad, or through spoken commands, and creates an instruction that is given to the customer care centers and subsequently to the respective service provider (where applicable). This system often works in conjunction with live agents to identify the nature of a call. These systems are also able to process more complex inquiries, such as the balance of a checking account or the status of a pending credit card transaction. However, IVR systems are limited to a small list of options. Currently, web based support is one of the most popular technique of providing customer assistance. Support is not limited to offering a help line number or web page to send mail queries. For example, a telecom service provider or an electric energy provider can have a website where customers can log-in to see their bills, pay their electricity bills or top-up there subscription, see usage information, get product/service information, checkout offers etc. This gives a unique experience of control to the customer and helps in getting information which was previously available only from a customer care executive or IVR. In addition to web based support, some vendors also provide detailed manuals for customer self-care as well as software tools that help in configuration and troubleshooting. A common example is the configuration of modems from internet service providers. The software provided along with the modem can not only help in self-set-up and configuration, but also has functionalities that diagnose the problems and provides the customer with inputs for troubleshooting problems. These types of technical issues usually required a phone call with the support desk or paying a field agent to configure the modem for the technical support service.

Mobile customer assistance can be also addressed by deploying thick applications that are installed on the mobile device. The rich look and feel offered by thick mobile applications makes it more attractive and user-friendly for a customer. Alternatively, applications can be deployed as thin applications that are rendered in the device's browser using technologies such as HTML5. Deployment of a thick or thin application depends on the application complexity, device support, requirements for user experience etc. The usual approach is to launch all these types, starting with the common SMS and Unstructured Supplementary Service Data (hereinafter referred to as ‘USSD’), followed by thin application for view on web browser. The current mobile assistance solutions are more a set of stored datasets which are merely queried on demand.

Mobile customer care solutions follow traditional approach of offering assistance based on specific request from the user. It lacks the ability to provide context based intelligent assistance.

Disclosed herein are improved methods and systems for customer assistance using wireless devices.

### SUMMARY OF THE INVENTION

Aspects of the disclosure relate to a system and method for customer assistance systems and methods for wireless telecommunication devices.

It is therefore one object of the present disclosure to provide systems and methods incorporating a multi-channel approach for providing customer assistance solutions. A Feed Engine, an Event Engine and an Intelligent Engine co-ordinate to provide multiple channels of providing customer assistance to mobile users using feeds, pre-defined events or proactive information.

It is another object of the present disclosure to provide a feed engine capable of providing a customer assistance solution based on a plurality of feeds. A Feed Handler on a server communicates with a Query Manager on a mobile device of a user to provide customer assistance based on one or more feeds.

It is yet another object of the present disclosure to provide an event engine capable of providing a customer assistance solution based on pre-defined events. An Event Manager on a mobile device of a user communicates with an Event Handler on a server for pre-defined business rules pertaining to mobile customer assistance.

In another object of the present disclosure, an intelligent engine is provided to enable enhanced proactive customer assistance. An Intelligent Client on a mobile device of a user identifies the utilization patterns occurring on the mobile device. These patterns are correlated by an Intelligent Center on a server and selective information is supplied to the user for mobile customer assistance.

The above as well as additional aspects and advantages of the disclosure will become apparent in the following detailed written description

### BRIEF DESCRIPTION OF THE DRAWINGS

The aspects of the disclosure will be better understood with the accompanying drawings.

FIG. 1 (PRIOR ART) is a block diagram of a mobile device to which the present disclosure may be applied.

FIG. 2 shows a schematic block diagram to illustrate a mobile computing environment in a wireless telecommunications system with a framework for implementing multi-channel customer assistance methods in accordance with the present disclosure.

FIG. 3 shows a schematic block diagram to illustrate a mobile computing environment in a wireless telecommunications system with a framework for implementing customer assistance methods using a feed engine.

FIG. 4 shows a schematic block diagram to illustrate a mobile computing environment in a wireless telecommunications system with a framework for implementing customer assistance methods using an event engine.

FIG. 5 shows a schematic block diagram to illustrate a mobile computing environment in a wireless telecommunications system with a framework for implementing customer assistance methods using an intelligent engine.

While systems and methods are described herein by way of example and embodiments, those skilled in the art recognize that systems and methods disclosed herein are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide systems and methods for implementing multi-channel customer assistance solutions. To facilitate a clear understanding of the present disclosure, illustrative examples are provided herein which describe certain aspects of the disclosure. However, it is to be appreciated that these illustrations are not meant to limit the scope of the disclosure, and are provided herein to illustrate certain concepts associated with the disclosure.

It is also to be understood that the present disclosure may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture.

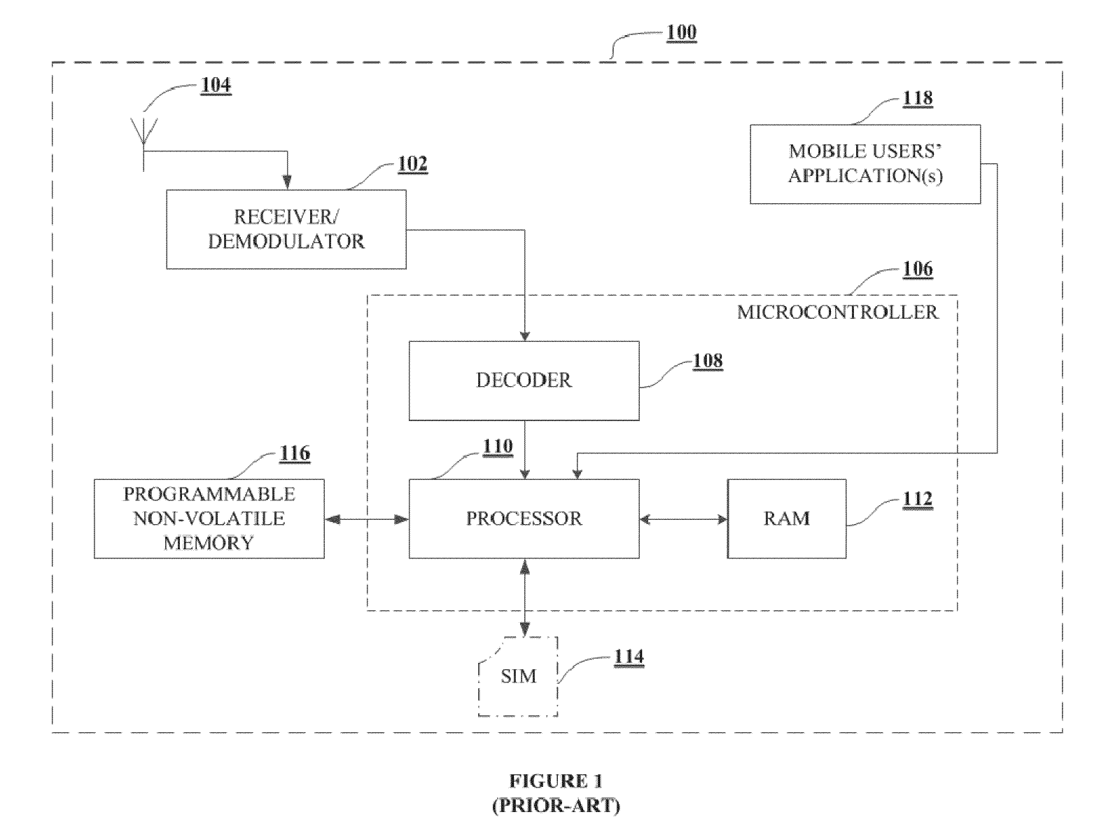

FIG. 1 (Prior-Art) illustrates a mobile device 100 on which the customer assistance system can be implemented in accordance with several embodiments of the system. The term ‘Mobile Device’ as used herein, refers to any kind of device capable of using data transmission means for telecommunication. The components within the mobile device 100 allow the device to integrate both handset-based services and network-based services. A receiver/demodulator 102 receives a transmitted signal via an antenna 104 and reconstructs the original transmitted signal. The transmitted signal is sent to a microcontroller 106, which consists of a decoder 108, a processor 110, and Random Access Memory (hereinafter referred to as ‘RAM’) 112. The decoder 108 translates the signals into meaningful data and interfaces to other devices. Decoded data, along with user inputs are sent to the processor 110. The term ‘user’ as used herein, refers to users equipped with the mobile device 100. The mobile device may also include a subscriber identity module (hereinafter referred to as ‘SIM’) 114. The output of the processor 110 can be stored in a programmable non-volatile memory 116 or in the RAM 112. Additionally, the SIM card may contain any or all of the processing components, memory components or storage components described herein. To that end, the device may perform SIM card based processing, memory, or storage. According to an exemplary embodiment of the present disclosure, the mobile device may include optional components, such as a data collection unit linked to the processor 112, which can include an automated Radio Frequency Identification (hereinafter referred to as ‘RFID’) tag reader, a magnetic card swipe reader, a bar code reader, and others. Additionally, or alternatively, the mobile device may include a biometric reader and/or a media output device (for example, MP3 player). An authentication may also be implemented using the SIM 114 to meet network requirements for desired levels of security. According to another exemplary embodiment of the present disclosure, the mobile device 100 may include one or more device applications 118 to provide additional functionality to the mobile device. The applications 118 are processed by the processor 112.

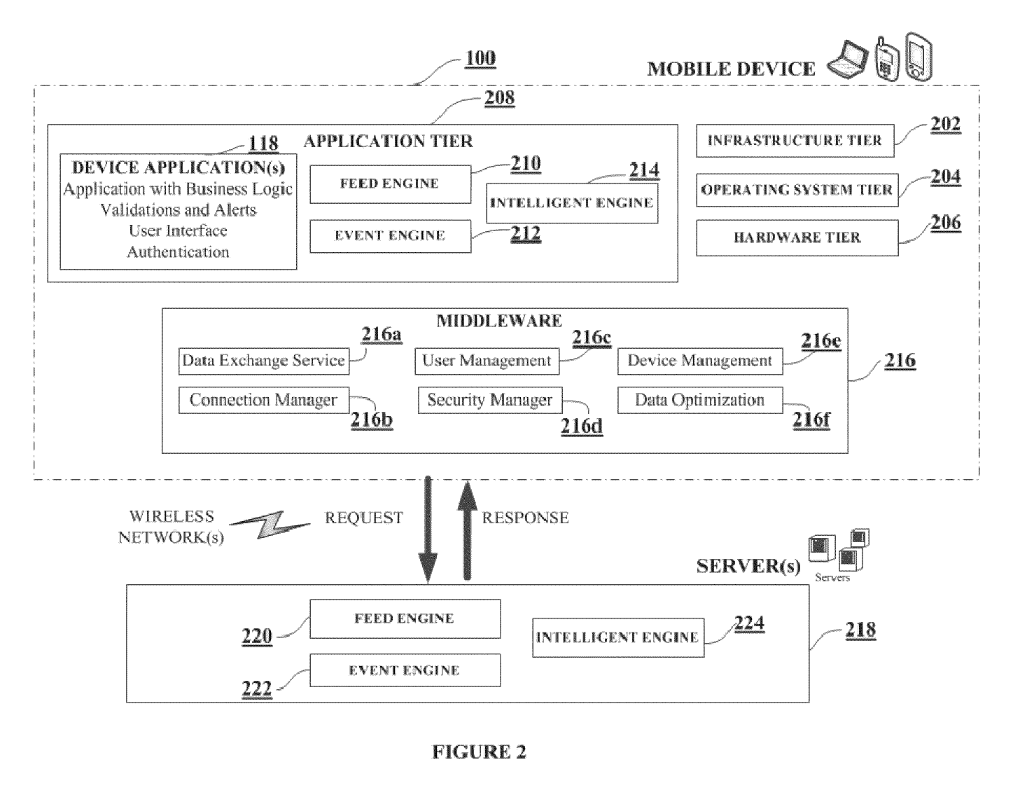

FIG. 2 shows a schematic block diagram to illustrate a mobile computing environment in a wireless telecommunications system with a framework for implementing multi-channel customer assistance methods in accordance with the present disclosure. FIG. 2 and the discussion herein provide a brief, general description of a suitable telecommunications or computing environment in which the system can be implemented. A mobile device 100 has an infrastructure tier 202, an operating system tier 204, a hardware tier 206, an application tier 208 and a middleware 216. The infrastructure tier 202 comprises of functional components operated by a mobile carrier or an infrastructure provider. This tier encompasses protocols which include code division multiple access protocol (hereinafter referred to as ‘CDMA’), global system for mobile communications (hereinafter referred to as ‘GSM’), global positions systems (hereinafter referred to as ‘GPS’) and short messaging system (hereinafter referred to as ‘SMS’), amongst others. The operating system tier 204 corresponds to software running on the mobile device 100, which allows communications between the hardware tier 206 and the application tier 208. The application tier 208 communicates with the operating system tier 204 to consume resources for the operation of one or more applications. The hardware tier 206 communicates with the operating system tier 204 to run processes and pass data to and from the mobile device 100. The application tier 208 utilizes application programming interfaces (hereinafter referred to as ‘API’) provided by the operating system tier 204. A user of the mobile device 100 interfaces with a plurality of device applications 118, which are functional software units, loaded and installed on the mobile device. Device applications are software that connect to the middleware 216 and drives both the user interface and the business logic on the device. These applications use the operating system tier 204 as a platform to launch applications. Device applications include programmable clients, which allow implementation of interactive user interfaces, customer-specific business rules and validations. Other application functions might include sending and receiving documents, and capturing customer signatures. The present disclosure provides proposes additional applications for customer assistance which includes a feed engine 210, an event engine 212 and an intelligent engine 214. It is a fundamental principle of the present disclosure that service is embedded directly into the mobile device 100 in the form of these engines. These embedded components may be present in the mobile device individually or in combinations. The feed engine 210 provisions automated customer assistance based on a plurality of feeds. The term ‘feed’ as used herein, are data formats used for providing users with frequently updated content. Content distributors publish feed links on their source locations to which users can register. The details and the working of the feed engine will be described with the help of subsequent figures. The presence of event engine 212 in the application tier 208 enables the implementation of customer assistance based on one or more triggering events. The details and the working of the event engine will be described with the help of subsequent figures. The intelligent engine 214 enables implementation of a corrective, preventive or improvement actions for the user to provide enhanced customer service. The details and the working of the intelligent engine will be described with the help of subsequent figures. The middleware 216 includes at least one application programming interface (API) to provide various services for the application tier. Essentially, it maintains system integration, security, communications, scalability, cross-platform support etc. Actual functions and capabilities can vary between service providers. According to an embodiment of the present disclosure, the middleware 216 comprises a data exchange services unit 216a, a connection manager unit 216b, a user management unit 216c, a security manager unit 216d, a device management unit 216e and a data management unit 216f. The data exchange services unit 216a composes changes from the back-end for the user to be sent to the mobile device. It runs as recursive service, running regularly in periodic intervals. The connection manager unit 216b handles multiple connections at the same time from the users up to a maximum number of concurrent users. The user management unit 216c manages the users. The user list can be linked with directory services for using the authentication system of the mobile device. The security manager unit 216d encrypts data being sent from the mobile device and decrypts data coming from the mobile device. The device management unit 216e is responsible for managing device related issues. The data optimization unit 216f optimizes the way data is being sent to the mobile device.

In a distributed system, an application is organized into different modules consisting of different processes which are distributed to different nodes and data is exchanged by means of a communication network. Communication to back-end services employs standard protocols designed for wireless connectivity, for example, GPRS, Enhanced Data for GSM Environment (hereinafter referred to as ‘EDGE’), amongst others. Where this network is in place, a Wireless Application Protocol (hereinafter referred to as ‘WAP’) gateway is required and utilizes the WAP protocol. The distributed system adopts a client-server model. The middleware 216 enables parameter based services to be requested from remote components, for example a server 218 in order to handle client-server operations. The server typically resides behind a firewall of an enterprise, or, alternatively, may be hosted by a service provider. The server 218 performs the request and sends the results back to the client. The term ‘client’ as used herein, refers to an application which requests an access to a service made available by a server 218. The ‘client’ operates on the mobile device 100 and server 218. Those skilled in the relevant art will recognize that the distinction between a client and server is purely based on function. A server could be a client of another server. The terms ‘client’, ‘application’ and ‘device applications’ are generally used interchangeably herein. The feed engine 210, event engine 212 and intelligent engine 214 residing on the mobile device 100, along with the feed engine 220, event engine 222 and the intelligent engine 224 residing on the server 218 will be described below.

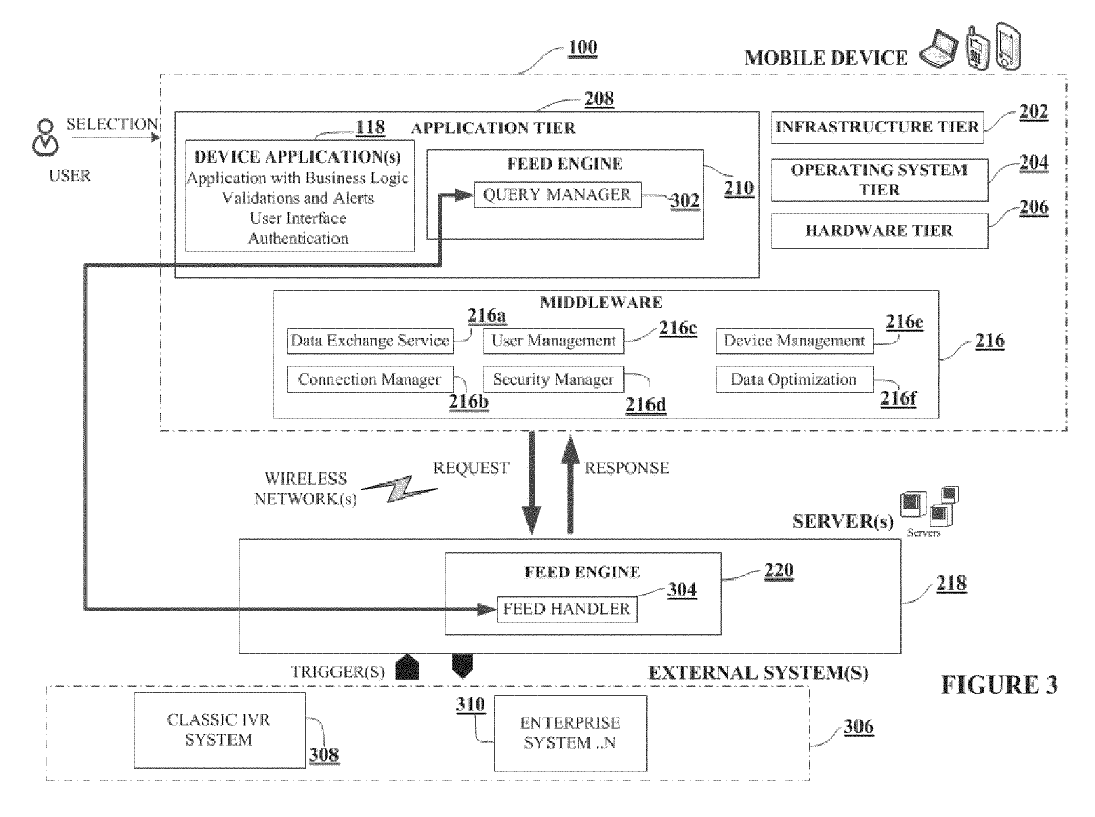

FIG. 3 shows a schematic block diagram to illustrate a mobile computing environment in a wireless telecommunications system with a framework for implementing customer assistance methods using a feed engine. The framework includes two components: the feed engine 210 residing on the mobile device 100 and the feed engine 220 residing on the sever 218. As used herein, the feed engine 210 is a software program installed and loaded on the mobile device 100 or associated memory device, both permanently and temporarily connected via hardware or wireless connectivity. A query manager 302 receives input from a feed handler 304 on the server 218. As used herein, the feed handler 304 is a software program installed and loaded on the server 218. The data processing, business logic and co-ordination between modules for enabling customer assistance based on selection are managed using feed handler 304. The feed given by the server 218 in response to the user's query can be a standard user interface based on user's last selection. Alternatively, the feed handler may be configured to work on multi-feeds. The feeds to mobile device can be based on users' last selection or client on a previous selection from user or the last selection made by user. The query manager 302 displays options or data to be entered by user as in classic IVR. The query manager 302 sends user's selection to feed handler 302. This information is then made available for use by various applications through one or more external systems 306 which act as an interface support framework. According to an exemplary embodiment of the present disclosure the feed handler exchanges data with one or more external systems, which include, but not limited to, a classic IVR 308 system to trigger actions. When the customer assistance supports voice based selection, the IVR service interfaces can be re-used while developing the customer assistance solutions. The IVR solution offers a tight integration with customer care centers' modules which could also be utilized. Those skilled in the art will recognize that several service systems, for example, in Telco service system, the Service Delivery Platform (hereinafter referred to as ‘SDP’) can provide customer location information, for location based service, it can have a charging engine to get and update account related information. Other examples of subsystem in Telco are SMS and USSD, both of which can be used to provide customer assistance. SMS Gateway can be used to send details of product and service offers and USSD can be used for getting message pop-ups like the charges from the last call placed, the amount debited for downloading a song, amongst others. According to another embodiment of the present disclosure, the feed handler 304 sends data to middleware server that interacts with one or more enterprise systems 312. Communication with enterprise systems 312 is accomplished using the server 218 which communicates with the mobile device 100 in one direction and with enterprise systems over secure connections using transports such as VPNs or HTTPS in the other direction. The sub-systems with which the server 218 may integrate from enterprise system 312 are dependent on the product or service for which customer assistance is offered. Some of the minimal enterprise subsystems include the web services for mobile commerce transactions for the specific product or service. The above disclosed selection based customer assistance systems and methods ease the handling of customer requests by customer care centers by reducing manual intervention and provide the user with greater flexibility.

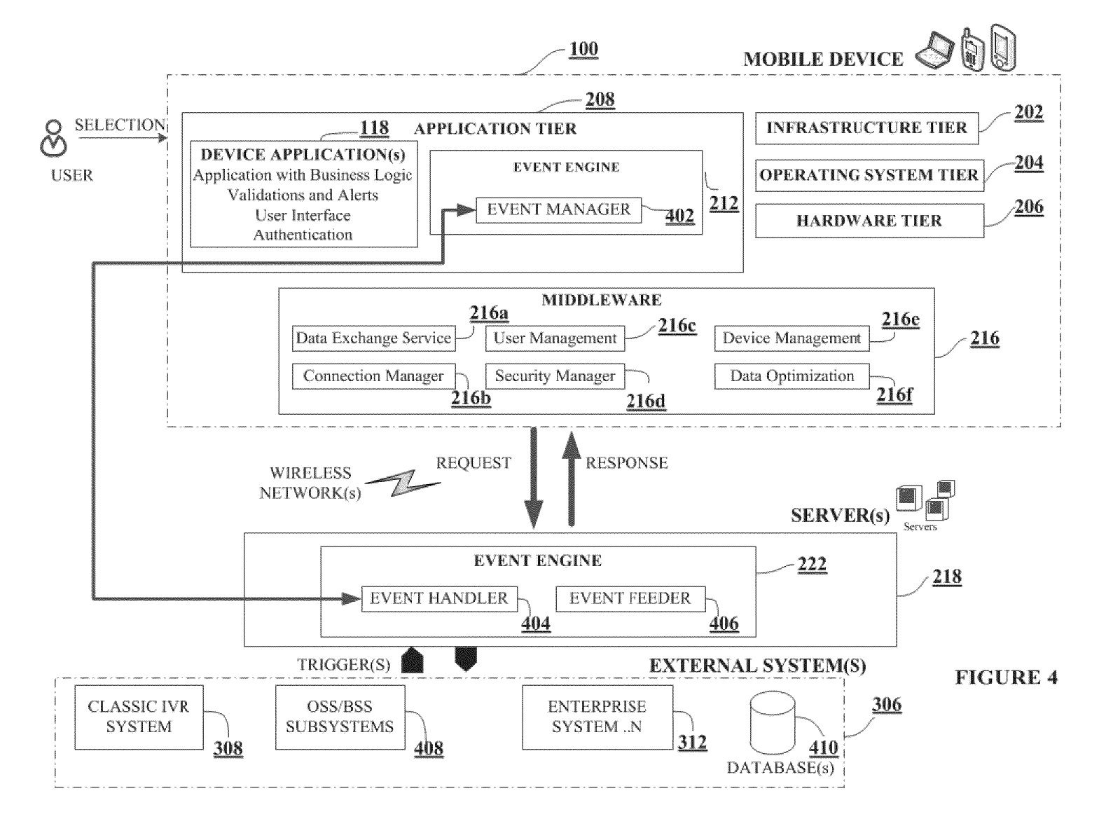

FIG. 4 shows a schematic block diagram to illustrate a mobile computing environment in a wireless telecommunications system with a framework for implementing customer assistance methods using an event engine. The framework includes two components: the event engine 212 residing on the mobile device 100 and the event engine 222 residing on the sever 218. As used herein, the event engine 212 is a software program installed and loaded on the mobile device 100 or associated memory device, both permanently and temporarily connected via hardware or wireless connectivity. An event manager 402 on the mobile device 100 performs the function of responding to a plurality of predefined events triggered from an event handler 404 on the server 218. The term ‘predefined events’ as used herein refers to a set of business rules applied for information processes pertaining to customer assistance. The predefined events include the domain knowledge coded in the form of rules supported by the mobile device 100. An information process pertaining to customer assistance is executed in response to the one or more predefined events. The term ‘event handler’ as used herein, is a software program installed and loaded on the server 218 and performs the task of handling the business logic i.e. rules for generating triggers. For example, when a call is disconnected due to low account balance, a mobile application can be launched informing the user of the insufficient balance and providing the user with an option to recharge the account. The message can be in the form of text, voice or a combination of both. According to one embodiment of the present disclosure, the event engine may be implemented by product vendors. For example, when a marketing article in the shopping page is out of stock, a mobile application may be launched to provision the user with alternative shopping sources from where the marketing article may be purchased. The mobile application may also suggest alternate marketing articles that can be purchased and enables the user to place an order. The set of trigger events are customizable on the server 218 using an event feeder 406. The event feeder 406 communicates with the event handler 404 to provide an update pertaining to one or more events. According to an exemplary embodiment of the present disclosure the event handler exchanges data with one or more external systems, which include, but not limited to, an operational support system (hereinafter referred to as ‘OSS’) or a business support system (hereinafter referred to as ‘BSS’) 408 to trigger actions. The OSS/BSS subsystem integration is important this kind of customer assistance. The user can have the capability to restart or re-configure a service, or corrective action based on events can be triggered to OSS/BSS systems. According to another exemplary embodiment of this invention the event feeder 406 receives input from one or more databases 410 for capturing data for various trigger events, for example, cross-selling and product marketing information, amongst others. Unlike selection based customer assistance method described in FIG. 3 based care, the above described event based customer assistance does not require the user to make a selection.

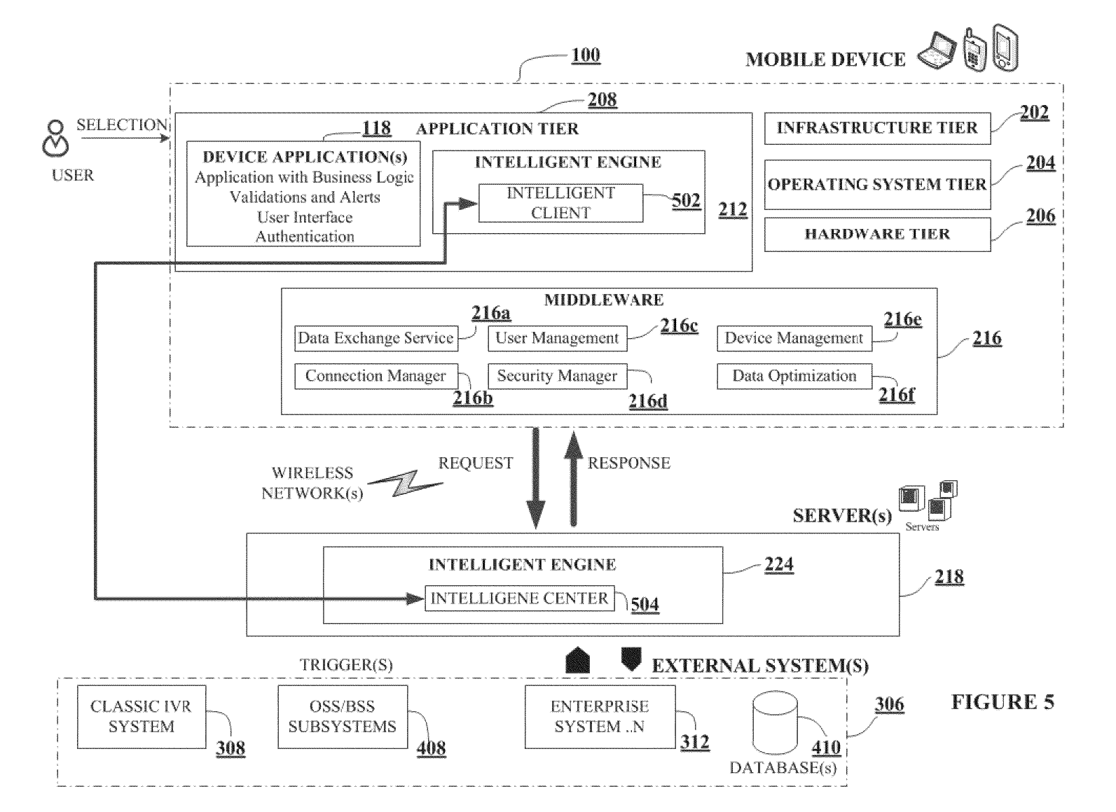

FIG. 5 shows a schematic block diagram to illustrate a mobile computing environment in a wireless telecommunications system with a framework for implementing customer assistance methods using an intelligent engine. The framework includes two components: the intelligent engine 214 residing on the mobile device 100 and the intelligent engine 224 residing on the sever 218. The terms, ‘intelligent client’ 502 and ‘intelligent center’ 504 as used herein, refer to software installed and loaded on the mobile device 100 and the sever 218 respectively. The intelligent client 502 and intelligent center 504 are configured to integrate mobile computing and provide the infrastructure to reason about the users' context which will primarily enable the intelligent engine to predict the users' intent and actions. According to the present disclosure, the intelligent client 502 on the mobile device 100 automatically gathers information about the mobile users' usage patterns and interests to provide enhanced care to the user. Some of the data collected by the intelligent client include for example, time spent on a specific page to retrieve information about a product or a service. This may aid in identifying the cross-selling options available and be added as a triggering event by the event engine 222. Other examples include identifying specific products that may of interest to the user as shown from the frequent visits. This information can be used in planning new product or service strategies or to check the effectiveness of a new promotion. Other type of information may include gathering information such as configuration data consisting of any or all of configuration settings, resident applications, and diagnostic data. The diagnostic data may include make and model of the device, total and available memory, total and available storage, battery life, connection strength, connection settings, user requests, usage statistics, soft reset count, recently used applications, amongst others. This data is represented as digestible information and the meaning is inferred of this information. This helps the customer assistance methods to be more proactive, requiring less user input. According to an exemplary embodiment of the present disclosure, the gathered data can be correlated to the users' profile. Preferably, the device profile data is transmitted over-the-air using for example, GPRS, CDMA, SMS, WiFi, Bluetooth, or infrared, or a combination of any of these. The area from which most errors are getting reported may be highlighted to indicate an occurrence of an issue. The intelligent client 502 sends data to the intelligent center 504 where the data is processed and corrective, preventive or improvement actions are triggered to middleware 216, IVR 308, OSS/BSS 408 or enterprise systems 312. The data exchanged may be pre-processed for meaningful data for quick decision making.

These embodiments may be implemented with software, for example modules executed on computing devices such as mobile device 100 of FIG. 1. Of course, modules described herein illustrate various functionalities and do not limit the structure of any embodiments. Rather the functionality of various modules may be divided differently and performed by more or fewer modules according to various design considerations. A combination of these engines may be provided, as per FIG. 2 to provide a packaged customer assistance solution. The type of application, the platforms to be supported along with the type of middleware may vary from one service provider to another. The right choice of platform and engines is based on the specific requirements in platforms to support back-end integration and features required, amongst others.

In additional to offering a self-help approach of customer assistance, the system can also interfaces with traditional channels like calling support desk or IVR number from with-in the system itself

Having described and illustrated the principles of the disclosure with reference to described embodiments and accompanying drawings, it will be recognized by a person skilled in the art that the described embodiments may be modified in arrangement without departing from the principles described herein.

What is claimed is:

1. A mobile customer assistance enabling framework in a carrier network, the framework comprising:
a Feed Engine, configured to receive responses corresponding to a plurality of feeds;
an Event Engine, adapted to respond to one or more predefined events; and
an Intelligent Engine, adapted to provide to a user of a mobile device with a set of proactive information;
wherein, the one or more engines reside on the mobile device and a server;
wherein the server is coupled to one or more external systems;
wherein, the one or more engines are adapted in a mobile communication environment for enabling a mobile customer assistance system.

2. The mobile customer assistance enabling framework in accordance with claim 1, wherein the external systems comprise at least one of an operational support system or a business support system or an enterprise systems and databases or combinations thereof.

3. The mobile customer assistance enabling framework in accordance with claim 1, wherein the Feed Engine further comprises:
a Feed Handler residing on the server, wherein the Feed Handler directs data to the one or more external systems, coupled to the server; and
a Query Manager on the mobile device, configured to receive a response associated with the plurality of feeds, wherein the response is received from the Feed Handler.

4. The mobile customer assistance enabling framework in accordance with claim 1, wherein the Event Engine further comprises:
an Event Handler on the server; and
an Event Manager on the mobile device;
wherein the Event Manager is adapted to respond to one more predefined events triggered by the Event Handler.

5. The mobile customer assistance enabling framework in accordance with claim 4, wherein the Event Engine further comprises a graphic user interface on the server to customize an Event Feeder on the server

6. The mobile customer assistance enabling framework in accordance with claim 4, wherein the predefined events correspond to business rules applied for information processes pertaining to mobile customer assistance.

7. The mobile customer assistance enabling framework in accordance with claim 4, wherein an information process is executed in response to the occurrence of one or more predefined events.

8. The mobile customer assistance enabling framework in accordance with claim 1, wherein the Intelligent Engine further comprises:
an Intelligent Client on the mobile device, adapted to communicate with an Intelligent Center on the server, to provide the user of the mobile device with a set of proactive information;
wherein the Intelligent Center is configured to identify utilization patterns of a user of the mobile device.

9. The mobile customer assistance enabling framework in accordance with claim 8, wherein the set of proactive information comprises information corresponding to mobile customer assistance.

10. The mobile customer assistance enabling framework in accordance with claim 9, wherein the set of proactive information comprises: a promotion associated information, information associated with a transaction payment and a relationship between the transaction payment method and a service provider.

11. A mobile device, for enabling a mobile customer assistance system, the mobile device comprising:
a processing sub-system having a processor and a memory, the memory capable of storing software components for execution by the processor, the software components comprising: a Query Manager, configured to receive a response associated with a plurality of feeds, wherein the response is received from a Feed Handler, residing on a server;
wherein the Feed Handler directs data to one or more external systems, coupled to the server.

12. The mobile device in accordance with claim 11, wherein the external systems comprise at least of an operational support system or a business support system or an enterprise systems and databases or combinations thereof.

13. A method for providing mobile customer assistance to a user, the method comprising:
sending, to a server, a request using a Query Manager, wherein the Query Manager corresponds to an interface residing in the software components of a mobile device of the user, wherein the request corresponds to a transaction;
receiving, a response from a Feed Handler on the server for an action to be performed in relation to the transaction, wherein the response comprises information corresponding to a plurality of feeds; and
performing, an action pertaining to the transaction,
wherein a transaction corresponds to a set of information pertaining to mobile customer assistance.

14. The method in accordance with claim 13, wherein the server is coupled to one or more external systems.

15. The method in accordance with claim 14, wherein the external systems comprise at least of an operational support system or a business support system or an enterprise systems and databases or combinations thereof.

16. The method in accordance with claim 13, wherein the plurality of feeds correspond to the user's last selection.

17. A mobile device, comprising: a processing sub-system having a processor and a memory, the memory capable of storing software components for execution by the processor, the software components comprising an Intelligent Client engine, adapted to communicate with an Intelligent Center engine on a server, to provide a user of the mobile device with a set of proactive information, wherein the proactive information corresponds to a transaction which is a set of information pertaining to mobile customer assistance.

18. The mobile device in accordance with claim 17, wherein the proactive information corresponds to corrective, preventive and improvement actions provided to the user of the mobile device.

19. The mobile device in accordance with claim 17, wherein the server is coupled to one or more external systems.

20. The mobile device in accordance with claim 19, wherein the external system comprises at least one of an operational support or a business support or an enterprise and databases or combinations thereof.

21. A method to implement a mobile customer assistance system for a user, the method comprising:
identification, by an Intelligent Client residing in a software component of a mobile device, utilization patterns of the user;
correlation, by an Intelligent Center on a server, the utilization patterns of the user with the profile of the user; and
proactively supplying information on the mobile device of the user, to define services in relation to mobile customer assistance.

22. The method in accordance with claim 21, wherein the server is coupled to one or more external systems.

23. The method in accordance with claim 22, wherein the external systems comprise at least of an operational support system or a business support system or an enterprise systems and databases or combinations thereof.

24. A mobile device, comprising: a processing sub-system having a processor and a memory, the memory capable of storing software components for execution by the processor, the software components comprising an event manager, adapted to respond to one or more predefined events triggered by an event handle engine on a server, wherein the one or predefined events correspond to business rules applied for information processes pertaining to mobile customer assistance.

25. The mobile device in accordance with claim 24, wherein an information process corresponding to mobile customer assistance is executed in response to the one or predefined events.

26. The mobile customer assistance enabling framework in accordance with claim 24, wherein the server is coupled to one or more external systems.

27. The mobile customer assistance enabling framework in accordance with claim 26, wherein the external systems comprise at least of an operational support system or a business support system or an enterprise systems and databases or combinations thereof.

28. A method to implement a mobile customer assistance to a user, the method comprising:
receiving, by an Event Handler on a server, one or more predefined events, wherein the predefined events correspond to business rules applied for information processes pertaining to mobile customer assistance; and
performing an action corresponding to the one or more predefined event provided to the user of a mobile device;
wherein, the one or more predefined events leads to execution of an information process pertaining to mobile customer assistance.

29. The method in accordance with claim 28, further comprising: a graphic user interface on the server to customize an Event Feeder on the server, coupled to one or more databases.

30. The method in accordance with claim 28, wherein the one or more predefined events comprises a virtual assistant offering event based response.

31. The method in accordance with claim 28, wherein the one or more predefined events comprises product marketing information.

32. The method in accordance with claim 28, wherein the server is coupled to one or more external systems.

33. The method in accordance with claim 32, wherein the external systems comprise at least of an operational support system or a business support system or an enterprise systems and databases or combinations thereof.
